(19) United States
(12) Patent Application Publication
(10) Pub. No.: US 2008/0262256 A1
(43) Pub. Date: Oct. 23, 2008

(54) Method for Efficiently Producing Methyltrioxorhenium(VII) (Mto) and Organorhenium (VII) Oxides

(75) Inventors: Wolfgang A. Herrmann, Freising (DE); Fritz E. Kuhn, Nandlstadt (DE); Richard Fischer, Bad Aibling (DE)

Correspondence Address: ROTHWELL, FIGG, ERNST & MANBECK, P.C., 1425 K STREET, N.W., SUITE 800, WASHINGTON, DC, 20005, US

(73) Assignee: CataTech Gmbh, Munchen (DE)

(21) Appl. No.: 11/661,385

(22) PCT Filed: Aug. 30, 2005
(86) PCT No.: PCT/EP05/09336

§ 371 Date: Jun. 11, 2008

(30) Foreign Application Priority Data
Aug. 30, 2004 (DE) 10 2004 041 933.7
Dec. 23, 2004 (DE) 10 2004 062 246.9

(51) Int. Cl. C07F 13/00

(52) U.S. Cl. 556/46

(57) ABSTRACT

The present invention relates to a novel process for preparing organorhenium(VII) oxides.

The present invention relates to a novel process for preparing organorhenium(VII) oxides.

Methyltrioxorhenium(VII) (MTO for short) as the parent compound of organorhenium(VII) oxides was reported for the first time in 1979 by I. R. Beattie and P. J. Jones (Inorg. Chem. 1979, 18, 2318.) It is formed in a yield of up to 50% from trimethyldioxorhenium(VI) (CH₃)₃ReO₂ or tetramethyloxorhenium(VII) (CH₃)₄ReO, with the starting compounds having to be exposed to dry air for a few weeks in order to effect the conversion into MTO.

Owing to the high time requirement, the precursors which are very difficult to obtain and the unsatisfactory product yields, this method of preparation was never of any importance. Instead, three alternative syntheses, which are organylations of various rhenium(VII) precursors, are customarily employed. These methods were developed by Hermann et al.
(1) The direct alkylation of dirhenium heptoxide Re₂O₇ (W. A. Herrmann et al., Angew. Chem. 1988, 100, 420) using nonreducing transfer reagents such as tetraalkyltin R₄Sn gives the corresponding organorhenium(VII) oxides in a smooth reaction. The greatest disadvantage of this method is that half of the rhenium used is obtained as polymeric trialkylstannyl perrhenate. The maximum theoretically possible yield is thus only 50% based on rhenium. The actual yield achieved is about 45% based on rhenium. If the toxic tin reagents R₄Sn are replaced by corresponding zinc reagents of the formula R₂Zn, these do effect alkylation but also the undesirable reduction of rhenium.
(2) In the so-called “anhydride route” (W. A. Herrmann et al., Inorg. Chem. 1992, 31, 4431), the alkylation is carried out using the mixed anhydrides of perrhenic acid and carboxylic acids. Here, dirhenium heptoxide is reacted successively with carboxylic anhydrides and tetraalkyltin compounds. When halogenated carboxylic anhydrides (preferably trifluoroacetic anhydride) are used, the yields are 80-90%, but the removal of the (trialkylstannyl)carboxylic anhydrides formed from the MTO formed requires many operations and is therefore time-consuming. The reaction indicated remains restricted to the few reactive tin compounds. It is thus limited in its synthetic range.
(3) According to a process patented in 1998 (patent: Aventis U.S. Pat. No. 6,180,807, DE 19717178), inorganic or organometallic perrhenates are reacted with a silylating reagent (preferably trimethylsilyl chloride TMS-Cl) and an organylating reagent (usually tetraalkyltin R₄Sn or dialkylzinc R₂Zn) to form the corresponding organorhenium(VII) oxide. When the difficult-to-obtain calcium perrhenate and tetramethyltin are used, the yield of MTO is 80%.

In all three processes, MTO is obtained in good yields only when tin(IV) compounds (e.g. Sn(CH₃)₄, CH₃Sn(n-C₄H₉)₃) are used as methylating reagent. This is a critical disadvantage since these very volatile compounds are acutely toxic and carcinogenic. The synthesis and also the purification of the organorhenium(VII) oxides therefore require a particular outlay in terms of work and apparatus and also a special laboratory or pilot plant facility. Extreme occupational hygiene precautions have to be taken. A further disadvantage is the high price of organotin compounds.

The dialkylzinc compounds which can be used in synthetic routes (1) and (3) are of less concern in terms of their toxicity but have other disadvantages which make the preparation of the products in relatively large quantities very difficult. Thus, the zinc alkyls R₂Zn, especially (CH₃)₂Zn and (CH₃CH₂)₂Zn, are spontaneously flammable. Good yields are rarely achieved and, in addition, the reaction has to be carried out at very low temperatures (−78° C. or below) since otherwise reduction of the rhenium(VII) precursors to rhenium compounds of a lower valence takes place. The work-up of such reaction mixtures is cumbersome and time-consuming. This leads to a significantly more difficult preparation and thus also to higher costs.

It was an object of the invention to provide a novel process by means of which organorhenium(VII) oxides can be obtained in good yields in a simple preparation, inexpensively and without the use of toxic, expensive organotin compounds. In particular, an effective synthetic process which can be employed for large amounts of product had to be found for the excellent catalyst MTO. On the basis of hundreds of studies in this field known from the literature, this objective seemed virtually hopeless. MTO and its derivatives have been a field which has been researched intensively worldwide for about 15 years.

Nevertheless, the object has surprisingly been achieved by the rhenium(VII)-containing precursor being reacted with a functionalized organylating reagent whose organylating properties are matched by means of particular substituents to the respective rhenium precursors and reaction conditions. The matching of the constitution of the reagent can also completely suppress its reducing action, which is undesirable, so that no rhenium compounds of lower valence occur among the products. This also simplifies the work-up of the target product. Compounds which have been found to be surprisingly efficient reagents for the preparation of, in particular, MTO are methylzinc carboxylates, halides and amides but also the solvent complex Al(CH₃)₃.(THF)ₙ where THF=tetrahydrofuran and n=1-3.

The invention thus provides a process for preparing an organorhenium(VII) oxide from a rhenium(VII)-containing precursor and a precisely functionalized organylating reagent.

Preferred examples of functionalizing radicals are halogens such as F, Cl, Br or I, pseudohalogens such as cyanide and thiocyanate (SCN), O-functional groups such as alkyloxy, aryloxy, alkylsiloxy or/and arylsiloxy, acyloxy, alkanesulfanyloxy or arylsulfanyloxy or N-functional groups such as amino, alkylamino or arylamino or metals of Main Group 1, e.g. Li⁺, Na⁺, K⁺, Rb⁺ or Cs⁺ or monohalogen compounds of metals of Main Group 2, e.g. MgBr or MgCl.

Preference is given to using an organometallic compound which contains at least one organic radical to be transferred to the rhenium(VII)-containing precursor and at least one functionalizing radical different therefrom, which can also be a Lewis-basic solvent ligand (e.g. THF), as functionalized organylating reagent.

In a preferred embodiment, the invention provides a process for preparing compounds of the formula (I)

RₐRe_{b}O_{c}L_{d} (I)

where

a=an integer from 1 to 6;

b=an integer from 1 to 4;

c=an integer from 1 to 13;

d=an integer from 0 to 6;

L=a Lewis-basic uncharged or anionic ligand which may optionally be joined to the group R;

and the sum of a, b and c is such that it satisfies the heptavalence of the rhenium, with the proviso that c is not greater than 4 times b, preferably not greater than 3 times b, and the radicals R are identical or different and are each an aliphatic hydrocarbon radical having from 1 to 20 carbon atoms, preferably from 1 to 10 carbon atoms, an aromatic hydrocarbon radical having from 6 to 20 carbon atoms, preferably from 6 to 10 carbon atoms, or an arylalkyl radical having from 7 to 20 carbon atoms, preferably 7-13 carbon atoms, wherein the radicals R may independently be substituted by one or more identical or different substituents and be joined to the ligand.

Substituents on the radical R are preferably selected from among halogen, hydroxyl, C₁₋₁₀-alkoxy, C₆₋₁₀-aryloxy, C₁₋₂₀-acyloxy, C₁₋₁₀-alkylamino or/and C₆₋₁₀-arylamino, where alkyl substituents may additionally be substituted by halogen or/and C₆₋₁₀-aryl and aryl substituents may additionally be substituted by halogen or/and C₁₋₁₀-alkyl. Particularly preferred examples of R are methyl, d₃-methyl, ethyl, propyl, cyclopropyl, phenyl, mesityl, cyclopentadienyl and chloromethyl.

Preferred examples of Lewis-basic uncharged ligands are pyridine, quinuclidine, pyrazole, tetrahydrofuran, acetonitrile and π-aromatics such as toluene. Preferred examples of Lewis-basic anionic ligands are halides and pseudohalides.

Suitable rhenium-containing compounds from which the class of substances (I) is prepared according to the invention are all compounds having a perrhenyl function “O₃Re⁺”, i.e. compounds of heptavalent rhenium having the general formula (II):

O₃ReX.Le (II)

where

e=an integer from 0 to 4;

L=a Lewis-basic uncharged or anionic ligand;

X=any radical having a formal single or multiple negative charge.

Preferred examples of Lewis-basic uncharged ligands are as indicated above.

The compound (II) is preferably an ester of perrhenic acid with an alcohol or silanol, a mixed anhydride of perrhenic acid with an organic acid, e.g. a carboxylic acid, an amide of perrhenic acid with ammonia or an amine or a halide of perrhenic acid.

Preferred examples of negatively charged radicals X are halides, e.g. Cl⁻, carboxylates such as acetate or trifluoroacetate, or perrhenate [ReO₄⁻]. Particularly preferred examples are the mixed anhydrides of perrhenic acid and carboxylic acids (e.g. O₃Re—OC(═O)CH₃ or O₃Re—OC(═O)CF₃) or O₃Re—[OC(═O)C₆H₅] or chlorotrioxo-rhenium.

In a further embodiment of the present invention, the required rhenium-containing compound of the formula (II) is prepared in situ from other rhenium-containing compounds (e.g. dirhenium heptoxide or a perrhenate) by reaction with an activating reagent (e.g. an acid anhydride or a halotrialkylsilane). Preferred examples of activating reagents are carboxylic anhydrides such as acetic anhydride, benzoic anhydride or trifluoro-acetic anhydride, or chlorotrialkylsilanes such as trimethylchlorosilane. In this way, the reactivity of the rhenium-containing substrate is matched to that of the organylating reagent.

As functionalized organylating reagents, preference is given to using compounds of the formula (III):

[R_{f}MX_{g}—Sₕ]ⁱ (III)

where
f=an integer from 1 to 6;
g=zero or an integer from 1 to 6;
h=zero or an integer from 1 to 5;
i=zero or a negative number (charge) of from −1 to −4, with a negative charge being balanced by any cations such as Li⁺, Na⁺, K⁺, [N(CH₃)₄]⁺, [P(C₆H₅)₄]⁺ of appropriate total charge;
M=Al, In, Ga, Cu, Zn, Sc, Y, La, a lanthanide (e.g.
Ce) or an element of Transition Group 4 of the Periodic Table of the Elements (PTE);
X=a halogen, cyclopentadienide, pseudohalogen, alkoxy, aryloxy, siloxy, oxide, sulfide, acyloxy, alkanesulfanyloxy, arylsulfanyloxy, amino, alkylamino, arylamino substituent, with the radicals X being identical or different;
S=a coordinated solvent molecule such as tetrahydrofuran, benzene, toluene or an organic amine,
   and the sum of f and g is such that it satisfies the valence of the metal M, and the radicals R are identical or different and each represent an aliphatic hydrocarbon radical having from 1 to 20 carbon atoms, an aromatic hydrocarbon radical having from 6 to 20 atoms or an arylalkyl radical having from 7 to 20 atoms, wherein the radicals R are selected independently and may be substituted identically or differently.

The functionalized organylating reagents can also be oligomeric or polymeric, with typical examples being dimethylaluminum oxide ((CH₃)₂Al—O—]ₓ and [CH₃Zn—O—]ₓ (x>2). A typical functionalized metal alkyl is, for example, the acid-base complex Al(CH₃)₃.(THF)ₕ (formula III; f=3, g=0, h=1-3).

M is preferably selected from among Zn, Cu, Al, Ti and lanthanides such as Ce. Particular preference is given to M═Zn.

X is particularly preferably an acyloxy or halogen group, e.g. Cl or acetate. Preference is likewise given to alkoxides and amides. Substituents of the group X are preferably selected from among C₁-C₆-alkyl radicals, e.g. methyl or ethyl, and C₆-C₁O-aryl radicals, where the alkyl radicals may be substituted by one or more halogen, hydroxyl, C₁-C₄-alkoxy or/and C₆-C₁₀-aryl radicals and the aryl radicals, in turn, may be substituted by halogen, hydroxyl or/and C₁-C₄-alkyl. Acyloxy radicals are preferably the radicals of C₁-C₆-alkylcarboxylic or C₆-C₁₀-arylcarboxylic acids, where alkyl and aryl may be substituted as indicated above.

The radicals R preferably have the meanings given for the compounds (I). R is particularly preferably selected from among methyl, d₃-methyl, ethyl, propyl, cyclopropyl, phenyl, mesityl, cyclopentadienyl and chloromethyl.

The variable nature of the substituent X enables the reactivity and solubility of the alkylating reagent to be matched very precisely to the reaction conditions and the respective rhenium precursor. The critical importance of the precise choice of the alkylating reagent to the success of the synthesis is shown, for example, by the reaction of Re₂O₇ with Zn(CH₃)₂ giving, as is known, reduced products such as (CH₃)₄Re₂O₄, while only the desired CH₃ReO₃ (MTO) is formed when CH₃Zn(OAc) or CH₃ZnCl is used.

In a further embodiment of the invention, the organylating reagent [R_{f}MX_{g}.Sh]¹ (III) is prepared in situ from suitable precursors. An example which may be mentioned is the in-situ synthesis of zinc compounds of the formula RZnX, where R and X are as defined above. One possibility here is treatment of zinc salts of the formula ZnX₂ with an organylating reagent which can transfer the desired group R. The synthesis of CH₃ZnCl can, for example, be carried out by reacting ZnCl₂ with methylating reagents such as CH₃Li, (CH₃)MgCl or methyl-containing aluminum reagents, in particular trimethylaluminum or dimethylaluminum chloride. Furthermore, methylzinc carboxylates can be synthesized in situ from dimethylzinc and carboxylic acids according to the equation (a):

Zn(CH₃)₂+R′—CO₂H→CH₃Zn[O(O═)C—R′]+CH₄T (equation a)

As an alternative, methylzinc compounds CH₃ZnX can also be obtained by reacting dimethylzinc with a zinc salt ZnX₂ according to the equation a′:

Zn(CH₃)₂+ZnX₂→2(CH₃)ZnX (equation a′)

Apart from matching of the reactivity, matching of the solubilities is also possible, and this critically influences the range of variation of the solvents which can be used. Thus, CH₃Zn(acetate) (R′═CH₃) is sparingly soluble in toluene, while CH₃Zn(benzoate) (R′═C₆H₅) is very readily soluble in this solvent. This can be important in industrial syntheses where the saving of solvents is important.

This method of preparation is novel. Compared to the preparative process represented by equation (a), this method of preparation has the advantage that the loss of methyl groups as methane is avoided. The comproportionation of dimethylzinc with the appropriate anhydrous zinc salt, for example zinc(II) acetate, can likewise be carried out in situ without isolation of the organylating reagent.

The reaction to prepare the class of substances (I) is carried out in a one-pot reaction in organic solvents, which are coordinating organic solvents such as acetonitrile, 1,2-dimethoxyethane, tetrahydrofuran or diethyl ether, noncoordinating solvents such as n-pentane, n-hexane, toluene, methylene chloride, chlorobenzene or solvent mixtures. The preparation is preferably carried out in donor solvents (e.g. tetrahydrofuran, acetonitrile). The reaction temperature varies, depending on the starting materials used, from −115 to +110° C., with preference being given to room temperature (25° C.). The reaction is preferably carried out in the absence of water.

In the preferred embodiment of the invention, MTO is prepared from Re₂O₇ in acetic anhydride, i.e. from perrhenyl acetate, and a CH₃Zn(carboxylate), especially CH₃Zn(acetate), preferably at room temperature in acetonitrile as solvent. The Re₂O₇ is activated before the methylation by converting it into O₃Re—OC(═O)CH₃ (perrhenyl acetate) in situ by means of acetic anhydride.

A further advantage of the synthetic method of the invention is the very short reaction times, usually less than one hour compared to a number of hours in the previously known synthetic methods. In addition, a protective gas atmosphere and other precautions can generally be dispensed with, so that the preparative process of the invention can be carried out quickly and inexpensively.

The avoidance of toxic contaminants in the products is a further characteristic of the invention: all preparative methods known hitherto, in particular for the parent substance MTO, were based on tin-containing alkylating or methylating agents (e.g. Sn(CH₃)₄, CH₃Sn(n-C₄H₉)₃) which appear as trace impurities also in the products and for this reason alone make particular precautions in the complicated product purification necessary. However, since the solubility in organic solvents and the volatility of product and toxic tin-containing contamination are comparable, complete avoidance of impurities has, for methodological reasons, hitherto only been possible with expenditure of considerable time and effort. The process of the invention is therefore fundamentally superior to the prior art for this reason, too.

The novel process is also considerably superior to the prior art in terms of its simplicity in the synthesis and work-up of even relatively large amounts of MTO. Thus, the reaction of the components in suitable solvents, preferably of CH₃Zn(OAc), e.g. in toluene, with O₃Re(OAc), e.g. in acetonitrile, can be carried out quantitatively and on a multikilogram scale. After mixing of the two components in solution at room temperature, an insoluble zinc acetate precipitates after a short time and only has to be filtered off. Removal of the solvent under reduced pressure leaves a residue of already very pure MTO which can be purified further if required simply by cold washing, e.g. with n-hexane, by sublimation, by Soxhlet extraction (in particular in the case of large batches) or by recrystallization. Thus, also the purification method can be matched to the specific way in which the preparation is carried out.

In another variant, a perrhenyl compound (II), e.g. O₃Re(OAc), can be reacted with the complex Al(CH₃)₃.(THF) at low temperatures in THF, toluene or comparable solvents to form CH₃ReO₃ (MTO) (n=1-3).

The quality of the reagents, in particular the Re₂O₇ used, has an influence on the purity and yield of the MTO. If CH₃Zn(OAc) or CH₃Zn(benzoate) is used as methylating reagent, this should preferably be slowly added in solution to the rhenium-containing component; otherwise, there is a risk of decreases in yield.

The organozinc carboxylates are cheap reagents which can even be handled in air and are nonflammable, in contrast to the diorganozinc compounds R₂Zn.

This method of preparation which can be scaled up to an industrial scale proceeds according to the equations (b) and (c) when the acetate group is used as carboxylate, with the process being generally applicable to carboxylates:

Re₂O₇+[CH₃C(═O)]₂O→2O₃Re—O—C(═O)CH₃ (b)

2O₃Re—O—C(═O)CH₃+2CH₃Zn[OC(═O)CH₃]→2CH₃ReO₃+2Zn[OC(═O)CH₃]₂ (c)

According to a further aspect of the present invention, the synthesis of organorhenium(VII) oxide can also be carried out without prior isolation of the organylating reagent of the formula (III). Here, dirhenium heptoxide can firstly be reacted in a suitable solvent, for example acetonitrile, with a carboxylic anhydride, e.g. acetic anhydride, according to equation (b). The molar ratio in this step is preferably about 1:1. The O₃Re-carboxylate formed, e.g. O₃Re—OAc can subsequently be combined with a solution in which an organylating compound of the formula (III) formed in situ is present. For example, a methylzinc carboxylate, e.g. CH₃ZnOAc, which can be prepared in situ by treating a zinc(II) carboxylate, e.g. zinc(II) acetate, with about ⅓ mol of trimethylaluminum can be present as organylating compound in this second solution. In this simplified, novel process variant, the expensive dimethylzinc is avoided, which is a particular advantage since this compound is expensive. In contrast, trimethylaluminum is a very inexpensive methylating agent. The methylzinc carboxylate, e.g. methylzinc acetate, produced according to equation (d) can be isolated in substance in a simple manner, but this is not absolutely necessary.

Zn[OC(═O)CH₃]2+⅓Al(CH₃)₃→CH₃Zn[OC(═O)CH₃]+⅓Al[OC(═O) CH₃]₃ (d)

The organorhenium(VII) oxide synthesized by the process of the invention does not necessarily have to be worked up, but can instead be reacted further in situ, e.g. as a solution. It can thus be immobilized in solution on an inorganic support material such as Al₂O₃, Al₂O₃/SiO₂, SiO₂ or Nb₂O₅ or mixtures of these oxides. The organorhenium(VII) oxide is preferably used as catalyst. Preferred fields for industrial use of organorhenium(VII) oxides are MTO-catalyzed olefin epoxidation and MTO-catalyzed oxidation of aromatics (Arco Chemicals U.S. Pat. No. 5,166,372; Hoechst AG DE 3 902 357, EP 90 101 439.9). On reaction with hydrogen peroxide H₂O₂, MTO is converted stepwise via a mono(peroxo)rhenium complex into a bis(peroxo)rhenium complex. The latter is the most efficient catalyst found up to now for the epoxidation of olefins.

Further preferred fields of use are the catalysis of the oxidation of aromatics (patent: Hoechst AG DE 44 19 799.3), olefin isomerization and olefin metathesis (patents: BASF AG DE 42 28 887; Hoechst AG DE 39 40 196, EP 891 224 370), carbonyl olefination (patent: Hoechst AG DE 4 101 737), Bayer-Villiger oxidation, Diels-Alder reaction and the oxidation of metal carbonyls, sulfides and many other organic and inorganic substrates. An overview is given by: C. C. Romao, F. E. Kuhn, W. A. Herrmann, Chem. Rev. 1997, 97, 3197-3246.

Furthermore, the organorhenium(VII) oxide can also be used for preparing high-purity rhenium oxides, e.g. by a CVD (chemical vapor deposition) process.

The invention is further illustrated by the following examples.

### EXAMPLES

Fundamentally, dried solvents and pure reagents have to be employed. The reagents are handled according to the prior art. Re₂O₇ should if possible be used in powder form. Acid anhydrides (e.g. acetic anhydride) have to be employed in acid-free form.

1. Preparation of Methylzinc Acetate

1a) from Acetic Acid and Dimethylzinc:

20 mmol of freshly distilled synthesis-grade acetic acid (1.21 g) together with 20 ml of dry n-pentane are placed under argon in a 250 ml round-bottom flask. This mixture is cooled to −78° C. while stirring vigorously. If the mixture is not stirred, the freezing acetic acid forms lumps. This is to be avoided. When the abovementioned temperature has been reached, 10 ml of a commercial 2M solution of dimethylzinc in toluene (20 mmol) are added by means of a syringe. This addition can be carried out very quickly, since no reaction occurs at the temperature indicated. The mixture is then stirred for another 20 minutes to ensure good homogeneity of the reaction mixture. After this period of time, the dry ice bath is removed and the mixture is allowed to warm up while continuing to stir vigorously. When the temperature goes above the range −30° C. to −20° C., vigorous evolution of gas commences. When this has abated (usually after 10 minutes at the latest), the reaction mixture is evaporated in an oil pump vacuum. This gives the product as a pure white solid in virtually quantitative yield (2.74 g, 98%). The yields are typically 95-99%.

1b) from Trimethylaluminum and Zzinc(II) Acetate:

Powdered zinc(II) acetate dihydrate is firstly dehydrated at 75° C. in a drying oven for 2.5 hours. 1.11 g (6.06 mmol, 1 molar equivalent) of anhydrous zinc acetate (finely powdered) are suspended in 5 ml of dry toluene under an inert gas atmosphere in a dried Schlenk tube and cooled to −10° C. 1 ml (2 mmol, 0.33 equivalents) of a commercial 2M solution of trimethylaluminum in toluene is slowly added to this suspension over a period of 30 minutes. The reaction mixture is stirred at a temperature of −5° C. in an acetone/dry ice bath for 5 hours. The solid is then filtered off and dried under reduced pressure. This gives 0.57 g of methylzinc acetate as a colorless powder as product. Typical yields are 65-80%.

In an analogous way, alkylzinc carboxylates can be obtained quite generally by the methods 1a) and 1b).

The batches under 1a) and 1b) can be increased without problems by a factor of 50-100 or more without a reduction in yield. It is merely necessary to use suitable laboratory apparatuses and to adapt the reaction times, if appropriate also the solvents, in an appropriate way.

2) to 9) Preparation of Methyltrioxorhenium

2) 1 g of dirhenium heptoxide Re₂O₇ is suspended in 5 ml of acetonitrile and admixed with one equivalent of acetic anhydride. The mixture is stirred at room temperature for 30 minutes and the resulting clear solution is slowly admixed with two equivalents of methylzinc acetate. After 30 minutes, the solution is filtered off from precipitated zinc acetate and evaporated to dryness. Washing with n-pentane having a temperature of −20° C. and drying gives analytically pure methyltrioxorhenium in a yield of 85%.

3) 100 g of dirhenium heptoxide Re₂O₇ are suspended in 250 ml of acetonitrile and admixed with one equivalent of acetic anhydride. The mixture is stirred at room temperature for 1 hour and the resulting clear solution is admixed with two equivalents of methylzinc acetate added a little at a time. This can be added as a solid or as a suspension in acetonitrile or toluene. After 30 minutes, the solution is filtered off from precipitated zinc acetate and evaporated to dryness. Subsequent washing of the product with n-hexane having a temperature of −20° C. gives analytically pure methyltrioxorhenium in a yield of 95%.

4) 1 g of dirhenium heptoxide Re₂O₇ is dissolved in 10 ml of THF and admixed with one equivalent of trifluoroacetic anhydride. The mixture is stirred at room temperature for 15-25 minutes, the solution is cooled to −78° C. and a solution of two equivalents of methylzinc chloride in 10 ml of THF which has been cooled to −78° C. is then added. (The methylzinc chloride was prepared in a customary laboratory synthesis from ZnCl₂ and CH₃MgCl in THF.) The mixture is stirred at −78° C. for another 15-30 minutes. 1 drop of water is then added and the mixture is allowed to warm to room temperature. The solvent is subsequently removed under reduced pressure and the residue is extracted by repeated refluxing with hot n-hexane. On cooling of the combined hexane fractions to −78° C., analytically pure methyltrioxorhenium precipitates as long needles in a yield of 76%.

5) 1 g of dirhenium heptoxide is dissolved in 10 ml of THF and admixed with two equivalents of trimethylsilyl chloride TMS-Cl. The mixture is stirred at room temperature for 30 minutes, the solution is cooled to −78° C. and a solution of two equivalents of methylzinc chloride in 10 ml of THF which has been cooled to −78° C. is then added. The mixture is stirred for another 15 minutes and the solvent is removed under reduced pressure. Subsequent sublimation gives analytically pure methyltrioxorhenium in a yield of 71%.

6) 1 g of silver perrhenate Ag[ReO₄] is suspended in 10 ml of THF and admixed with two equivalents of trimethylsilyl chloride TMS-Cl. The mixture is cooled to −78° C. and a solution of two equivalents of methylzinc chloride in 10 ml of THF which has been cooled to −78° C. is then added. The mixture is stirred for another 15 minutes and the solvent is removed under reduced pressure. Subsequent sublimation gives analytically pure methyltrioxorhenium in a yield of 52%.

7) 1.73 g (3.59 mmol, 1 molar equivalent) of dirhenium heptoxide is weighed into a Schlenk tube in a glove box and then suspended in 10 ml of acetonitrile. 0.36 g (3.59 mmol, 1 molar equivalent) of distilled acetic acid-free acetic anhydride is added to this suspension, resulting in the solid dissolving completely. Should this not be the case, an excess of acetic anhydride is added. The acetic anhydride used has to be boiled over anhydrous sodium acetate before use and after distillation stored over 3 Å molecular sieves; this ensures that no free acetic acid, which would even in very small amounts reduce the yield, is present.

The clear solution obtained is stirred for 15 minutes but preferably no longer, since the perrhenyl carboxylate can otherwise decompose. A solution of 1.00 g (7.17 mmol, 2 equivalents) of methylzinc acetate in 10 ml of toluene is then slowly added dropwise. A color change can sometimes be observed (e.g. depending on the purity of the Re₂O₇ used). After the addition is complete, the reaction mixture is stirred at room temperature for 1 hour. The solvent is then taken off under reduced pressure and the residue is dissolved in warm n-pentane. Crystallization is carried out at −78° C. At this temperature, only methyltrioxorhenium (and not the usually yellowish or reddish by-products which may be obtained in relatively small amounts) crystallizes. 1.50 g of white methyltrioxorhenium(VII) are obtained (yield: 84%). Typical yields are in the range 80-95%.

8) The preparative route under example 7) can be increased by a factor of 100 or more if the apparatuses required are adapted accordingly (glass flasks, stirrer, metering facilities, solvent, etc.). The work-up of relatively large amounts of the product CH₃ReO₃ can alternatively be carried out by means of Soxhlet extraction, e.g. using n-pentane. The yields are in the range 75-95%.

9) 50.0 g (103.22 mol) of Re₂O₇ together with 250 ml of THF are placed in a reaction vessel and admixed with one equivalent of acetic acid-free synthesis-grade acetic anhydride. The reaction mixture obtained is then stirred at room temperature for about 10-15 minutes. When clean starting compounds are used, the reaction mixture is clear and colorless to yellowish. If the Re₂O₇ is contaminated, stronger colors can occur and the addition of excess acetic anhydride can be necessary.

After the reaction mixture has been cooled to −78° C., 0.67 equivalent of a 1M solution of trimethylaluminum in toluene or THF is added slowly (preferably dropwise). The mixture is then slowly warmed to room temperature and stirred at room temperature for about 30 minutes. A significant deepening of the color can occur on warming.

Precipitated aluminum acetate is then filtered off, the solvent is carefully taken off and the residue is extracted a number of times with cold n-pentane. This gives 43.10 g (172.93 mol, 85%) of analytically pure MTO (mp: 111-113° C.). The yield (usually 70-95% of theory) is also dependent on the purity of the starting compound used.

Analysis: CH₃ReO₃

| | | | | |
|---|---|---|---|---|
| calculated: | C 4.99 | H 1.39 | O 19.21 | Re 74.76 |
| found: | C 5.00 | H 1.40 | O 19.16 | Re 74.60 |

¹H-NMR: δ(CH₃)=2.61 ppm (CDCl₃), 1.21 ppm (C₆D₆)

¹³C-NMR: δ(C)=19.03 ppm (CDCl₃)

¹⁷O-NMR: δ(O)=829 ppm (CDCl₃) 10) The examples shown in table 1 are carried out in a manner analogous to examples 1-9.

TABLE 1
Synthesis of organorhenium(VII) oxides

| Re compound/ | | | | |
|---|---|---|---|---|
| activating | Organylating | Conditions | | RReO₃ |
| reagent*⁾ | reagent^{*)} | Solv. | T[° C.] | Yield in % |
| Re₂O₇/Ac₂O | MeZn(OAc) | [c] | 25 | 80-95 [a] |
| Re₂O₇/(TFA)₂O | Zn(OAc)₂/AlMe₃ | [c] | 25 | 90-99 [a] |
| Re₂O₇/Ac₂O | Me₃Al•(S)ₕ | Solv.* | −78 | 60-80 [a] |
| Re₂O₇/Ac₂O | Zn(OAc)₂/AlMe₃ | [c] | 25 | 88-99 [a] |
| Re₂O₇/(TFA)₂O | MeZnCl | THF | −78 | 76-86 [a] |
| Re₂O₇/TMSCl | MeZnCl | THF | −78 | 71 [a] |
| Ag[ReO₄]/TMSCl | MeZnCl | THF | −78 | 52 [a] |
| Re₂O₇/Ac₂O | EtZn(OAc) | AN | 25 | 60 [b] |
| Re₂O₇/(TFA)₂O | MeCeCl₂ | THF | −78 | 35 [b] |
| Re₂O₇/(TFA)₂O | MeCuLi | THF | −78 | 20 [b] |
| Re₂O₇/(TFA)₂O | MeTi(OⁱPr)₃ | THF | −78 | 40 [a] |
| Re₂O₇/(TFA)₂O | ⁱPrZnCl | THF | −110 | 40 [b] |
| Re₂O₇/Ac₂O | MeZn(OBenz) | [c] | 25 | 79-95 [a,d] |

*⁾AN = acetonitrile; THF = tetrahydrofuran; Me = CH3; Et = C₂H₅, ⁱPR = iso-C₃H₇; Ac = acetyl, Benz = benzyl, TFA = trifluoroacetyl, TMS = trimethylsilyl.
Solv.* Solv. = THF, toluene or similar solvents
[a] Isolated pure yield.
[b] Yield determined by ¹H-NMR spectroscopy.
[c] Solvent: Re₂O₇ in AN, MeZn(OAc) or MeZn(OBenz) in toluene or THF.
[d] Owing to the good solubility of MeZn(OBenz), it is possible to make do with little solvent (toluene).

1. A process for preparing an organorhenium(VII) oxide from a rhenium(VII)-containing precursor and a functionalized organylating reagent.

2. The process as claimed in claim 1, wherein the organorhenium(VII) oxide is a compound of the formula RₐRe_{b}O_{c}L_{d} (I), where
a=an integer from 1 to 6;
b=an integer from 1 to 4;
c=an integer from 1 to 13;
d=0 or an integer from 1 to 6;
L=a Lewis-basic uncharged or anionic ligand which may optionally be joined to the radical R;
and the sum of a, b and c is such that it satisfies the heptavalence of the rhenium, with the proviso that c is not greater than 4 times b and the radicals R are identical or different and are each an aliphatic hydrocarbon radical having from 1 to 20 carbon atoms, an aromatic hydrocarbon radical having from 6 to 20 atoms or an arylalkyl radical having from 7 to 20 atoms, wherein the radicals R may be selected independently and be substituted by identical or different substituents.

3. The process as claimed in claim 1, wherein the rhenium(VII)-containing precursor is a compound having a perrhenyl function “O₃Re+” of heptavalent rhenium having the general formula O₃ReX.Lₑ (II), where
e=zero or an integer from 1 to 4;
L=a Lewis-basic uncharged or anionic ligand;
X=any radical having a formal single negative charge.

4. The process as claimed in claim 3, wherein the perrhenyl compound (II) is an ester, an anhydride, an amide or a halide of perrhenic acid.

5. The process as claimed in claim 2, wherein the compound (II) is prepared in situ from Re₂O₇ or a perrhenate and an activating reagent.

6. The process as claimed in claim 5, wherein an acid anhydride, preferably acetic anhydride, or a halotrialkylsilane is used as activating reagent.

7. The process as claimed in claim 1, wherein an organometallic compound which contains at least one organic radical to be transferred to the rhenium(VII)-containing precursor and at least one functionalizing radical different therefrom is used as functionalized organylating reagent.

8. The process as claimed in claim 1 wherein the functionalized organylating reagent is a monomeric, oligomeric or polymeric compound of the formula (III):
[R_{f}MX_{g}.Sh]ⁱ (III)
where
f=a number from 1 to 6;
g=zero or a number from 1 to 6;
h=zero or a number from 1 to 5;
i=zero or a negative number (charge) of from −1 to −4, with the negative charge being balanced by any cations of appropriate total charge;
M=Al, In, Ga, Cu, Zn, Sc, Y, La, a lanthanide (e.g. Ce) or an element of Transition Group 4 of the PTE;
X=a halogen, cyclopentadienide, pseudohalogen, alkoxy, aryloxy, siloxy, oxide, sulfide, acyloxy, alkanesulfanyloxy, arylsulfanyloxy, amino, alkylamino, arylamino substituent, with the radicals X not being present, identical or different;
S=a coordinated solvent molecule such as tetrahydrofuran or toluene, and the sum of f and g is such that it satisfies the valence of the metal M, and the radicals R are identical or different and each represent an aliphatic hydrocarbon radical having from 1 to 20 carbon atoms, an aromatic hydrocarbon radical having from 6 to 20 atoms or an arylalkyl radical having from 7 to 20 atoms, wherein the radicals R are selected independently and may be substituted identically or differently.

9. The process as claimed in claim 1, wherein a Zn-containing compound is used as functionalized organylating reagent.

10. The process as claimed in claim 1, wherein the functionalized organylating reagent uses a halogen compound or acyloxy compound.

11. The process as claimed in claim 1, wherein the functionalized organylating reagent is a compound RZnX in which X is carboxylate or halide and R is as defined above.

12. The process as claimed in claim 1, wherein the organylating reagent is an organocopper compound [R₂Cu]M′, where R is as defined above and M′ is a monovalent cation of Main Group 1 of the Periodic Table or a monohalogen compound of a divalent cation of Main Group 2 of the Periodic Table.

13. The process as claimed in claim 1, wherein the functionalized organylating reagent is prepared in situ from an auxiliary reagent.

14. The process as claimed in claim 13, wherein the organylating reagent is prepared in situ from LiR, AIR₃, AIR₂Hal or RMgHal, where R is as defined above and Hal is a halide, as auxiliary reagent.

15. The process as claimed in claim 1, wherein the functionalized organylating reagent is CH₃ZnX, where X is as defined above.

16. The process as claimed in claim 15, wherein CH₃ZnX is prepared in situ by treating zinc salts of the formula ZnX₂ with methyl-containing auxiliary reagents of aluminum, in particular AlMe₃ or AlMe₂Cl.

17. The process as claimed in claim 15, wherein the methylzinc reagent is methylzinc acetate which is obtainable from dimethylzinc and acetic acid according to equation (d):
Zn(CH₃)₂+AcOH→CH₃ZnOAc+CH₄ (equation d)

18. The process as claimed in claim 15, wherein CH₃ZnX is prepared by comproportionation of dimethylzinc with the corresponding zinc salt ZnX₂.

19. The process as claimed in claim 18, wherein the methylzinc reagent is methylzinc acetate which is formed in situ (i) from dimethylzinc and anhydrous zinc acetate, preferably in a molar ratio of about 1:1, or (ii) from trimethylaluminum and anhydrous zinc acetate, preferably in a molar ratio of about 1:3.

20. The process as claimed in claim 1, wherein the reaction is carried out in a coordinating or noncoordinating organic solvent.

21. The process as claimed in claim 1, wherein acetonitrile, toluene or tetrahydrofuran is used as solvent.

22. The process as claimed in claim 1, wherein dirhenium heptoxide is firstly treated in a solvent, preferably acetonitrile, with acetic anhydride and is subsequently reacted with methylzinc acetate.

23. The process as claimed in claim 1, wherein dirhenium heptoxide is firstly treated in a solvent, preferably tetrahydrofuran or acetonitrile, with trifluoroacetic anhydride and is subsequently reacted with methylzinc acetate.

24. The process as claimed in claim 1, wherein methyltrioxorhenium is prepared from chlorotrioxorhenium which is prepared in situ either from silver perrhenate Ag[ReO₄] and trimethylsilyl chloride or from dirhenium heptoxide and trimethylsilyl chloride.

25. The process as claimed in claim 1, wherein the synthesized organorhenium(VII) oxide is not worked up but is instead reacted further in situ as a solution.

26. The process as claimed in claim 1, comprising the steps:
(a) reacting a solution of dirhenium heptoxide with an anhydrous carboxylic anhydride, e.g. acetic anhydride, and
(b) reacting the reaction mixture from step (a) with a solution prepared by treating a zinc(II) carboxylate, in particular zinc(II) acetate, with trimethylaluminum,
where the molar ratio of zinc compound to dirhenium heptoxide is preferably 2:1.

27. The process as claimed in 25, wherein the synthesized organorhenium(VII) oxide is immobilized in solution on an inorganic support material.

28. The process as claimed in claim 1, wherein solvent complexes of trimethylaluminum, in particular of the formula Al(CH₃)₃.Sₕ (S=solvent molecule; h=1-3), are used as functionalized organylating reagent.

29. The process as claimed in claim 1, wherein the reaction product of the formula (I) is purified by recrystallization, vacuum sublimation or Soxhlet extraction.

30. The use of the organorhenium(VII) oxide prepared according to claim 1 as catalyst.

31. The use of the organorhenium(VII) oxide prepared according to claim 1 for preparing rhenium oxides by the CVD (chemical vapor deposition) process.
